(19) United States
(12) Patent Application Publication
(10) Pub. No.: US 2007/0068461 A1
(43) Pub. Date: Mar. 29, 2007

(54) Toileting Device for a Domestic Animal

(76) Inventor: Roger Bowden Hill, Johnsonville (NZ)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 11/535,379

(22) Filed: Sep. 26, 2006

(30) Foreign Application Priority Data
Sep. 27, 2005 (NZ) 542641

(51) Int. Cl. A01K 1/035

(52) U.S. Cl. 119/166

(57) ABSTRACT

A toileting device for a domestic animal. The toileting device comprises a textured surface and a liquid collecting structure. The textured surface has a plurality of apertures configured to allow the passage of liquid waste through the textured surface. The liquid collecting structure is positioned below the textured surface and has a drain and a nadir for guiding liquid waste to the drain.

### CROSS REFERENCE TO RELATED APPLICATION(S)

This application claims foreign priority to New Zealand Patent Application Serial Number: 542641 filed Sep. 27, 2005. The entire disclosure of which is herein incorporated by reference.

### BACKGROUND

1. Field of the Invention

This invention relates to a toileting device for a domestic animal.

2. Description of the Related Art

Domestic animals or pets, such as cats, often live indoors or spend a lot of time indoors. A cat often requires access to a device for toileting indoors. Such a device may comprise a tray or litter box with absorbent material such as an absorbent granular material, newspaper or similar absorbent material. The granular material, newspaper or absorbent material needs to be continually removed from the tray and replaced with fresh material. A disadvantage of using granular material or similar is the ongoing cost of replacing the material as it is used.

It is known to provide a screen over a toilet bowl for use by a domestic animal. For example, WO 88/02596 describes a sanitary device for cats and other small pet animals. A flat screen, described as a perforated central member, is supported on the rim of a conventional toilet by supporting members. The animal supports itself on the screen while toileting and waste travels through the screen into the toilet.

The main disadvantage of the product described in WO 88/02596 is that it must be assembled and disassembled whenever a pet wishes to use the device. This would have the disadvantage that a pet may wish to relieve itself at a time that is inconvenient or unsuitable to the owner or perhaps the pet is unable to communicate the desire to relieve itself to the owner. Furthermore, there would be a problem when a human wishes to use the toilet that the user must remove the screen and place the screen somewhere in the bathroom leading to possible hygiene problems.

PCT patent specification WO 2004/071182 describes a pet toileting device. A flat grating is supported by a frame. Within the frame is positioned a pad of sand, newspaper or similar absorbent material that is used to absorb liquid waste. The product described in WO 2004/071182 does not solve the problem of having to continually replace the absorbent material used to collect waste to reduce odour.

In this specification, where reference has been made to external sources of information, including patent specifications and other docurnents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### SUMMARY

In accordance with a first aspect of the present invention, there is provided a toileting device for a domestic pet, comprising: a textured surface having a plurality of apertures configured to allow the passage of liquid waste through the textured surface; a liquid collecting structure positioned below the textured surface having a drain and a nadir for guiding the liquid waste to the drain.

As used herein “(s)” following a noun means the plural and/or singular forms of the noun.

Preferably, the textured surface comprises a plurality of spaced apart projections.

Preferably, the upper portions of the projections are generally smooth.

Preferably, the upper edges of the projections are radiused or curved.

Preferably, the lower portions of the projections have relatively sharp edges.

Preferably, the textured surface further comprises elongate ribs connecting adjacent projections in one direction.

Preferably, the textured surface further comprises webs extending between adjacent projections in another direction.

Preferably, in plan view the projections are generally rectangular. Alternatively, in plan view the projections are generally tear drop shaped.

Preferably, the textured surface further comprises a cover positionable over the projections with a plurality of apertures corresponding to the plurality of projections.

Preferably, the drain comprises a water trap.

Preferably, the drain comprises: an upper plug receivable by the upper tray, the upper plug having a substantially funnel shape, and a lower plug receivable by the upper plug, the lower plug having an annular groove, the funnel and annular groove forming a drain passage when assembled.

Preferably, the drain may be positioned in a substantially central location of the upper tray. Alternatively, the drain may be positioned in a location offset from a central location of the upper tray.

In a preferred embodiment, the toileting device further comprises an air vent and an air filter.

Preferably, the textured surface is formed from a plastic material.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The invention consists in the foregoing and also envisages constructions of which the following gives examples only.

### BRIEF DESCRIPTION OF THE DRAWINGS

The present invention will now be described with reference to the accompanying drawings in which:

FIG. 1 shows a back view of a preferred embodiment toileting device;

FIG. 2 shows a side view of the toileting device of FIG. 1;

FIG. 3 shows a cross section of the toileting device of FIG. 1 with liquid passing through the textured surface and the drain passage;

FIG. 4 shows a cross section of the toileting device of FIG. 1 with liquid passing through the textured surface and the drain passage;

FIG. 5 shows a top view of the upper tray;

FIG. 6 shows a top view of a first preferred embodiment of the textured surface;

FIG. 7 shows a detail cross section view of the textured surface of FIG. 6;

FIG. 8 shows a detail cross section view of the textured surface of FIG. 6;

FIG. 9 shows a detail view of the top of the textured surface of FIG. 6;

FIG. 10 shows a top view of the first embodiment s-type drain;

FIG. 11 shows a side view of the first embodiment s-type drain;

FIG. 12 shows a bottom view of the first embodiment s-type drain;

FIG. 13 shows a cross section of the first embodiment s-type drain;

FIG. 14 shows a detail view of the first embodiment s-type drain installed in the upper tray;

FIG. 15 shows a detail view of the first embodiment s-type drain installed in the upper tray with liquid passing through the drain passage;

FIG. 16 shows an exploded cross section of the first embodiment s-type drain;

FIG. 17 shows a cross section of the second embodiment s-type drain;

FIG. 18 shows an exploded cross section of the second embodiment s-type drain;

FIG. 19 shows a front view of the inner trays;

FIG. 20 shows a side view of the inner trays;

FIG. 21 shows a top view of the inner trays;

FIG. 22 shows a cross section of a toileting device with one inner tray;

FIG. 23 shows a partial plan view of a second preferred embodiment of the textured surface;

FIG. 24 shows a side view of the textured surface of FIG. 23;

FIG. 25 shows a partial plan view of the draining surface of the textured surface of FIG. 23;

FIG. 26 shows a side view of the draining surface of FIG. 25;

FIG. 27 shows a detail side view of the projections of the draining surface;

FIG. 28 a partial plan view of the cover of the textured surface of FIG. 23;

FIG. 29 shows a side view of the cover of FIG. 28;

FIG. 30 shows a schematic perspective view of the draining surface of FIG. 25;

FIG. 31 shows a partial plan view of a third preferred embodiment of the textured surface;

FIG. 32 shows a side view of the textured surface of FIG. 31;

FIG. 33 shows a partial plan view of the draining surface of the textured surface of FIG. 31;

FIG. 34 shows a side view of the draining surface of FIG. 33;

FIG. 35 shows a detail side view of the projections of the draining surface;

FIG. 36 a partial plan view of the cover of the textured surface of FIG. 31; and

FIG. 37 shows a side view of the cover of FIG. 36.

### DESCRIPTION OF THE PREFERRED EMBODIMENT(S)

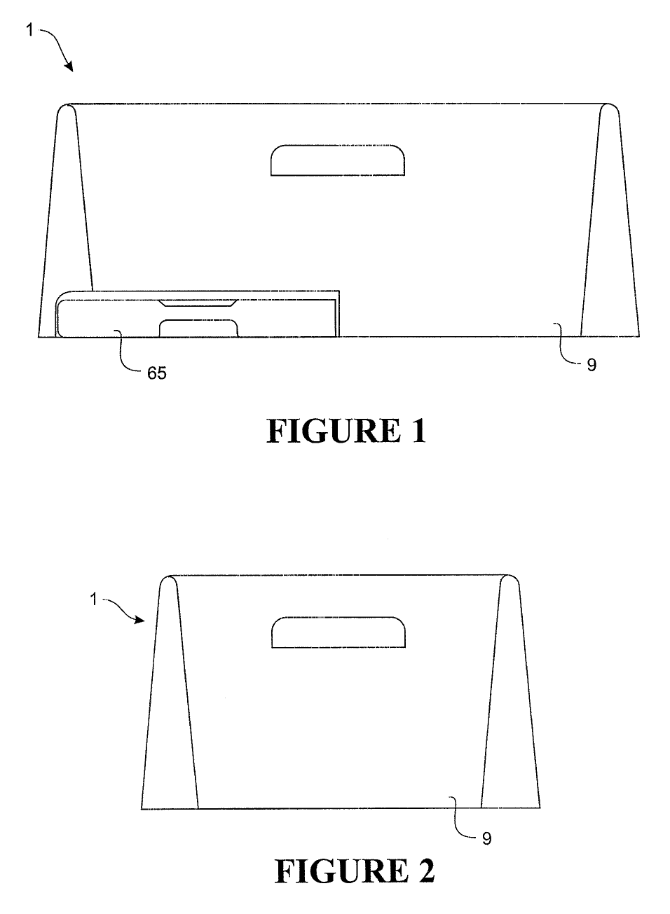

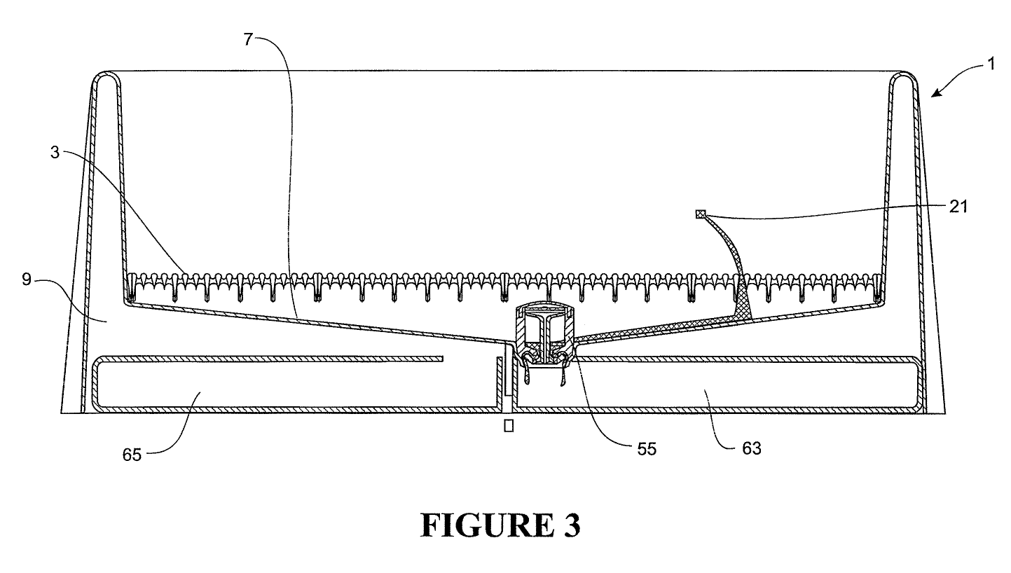

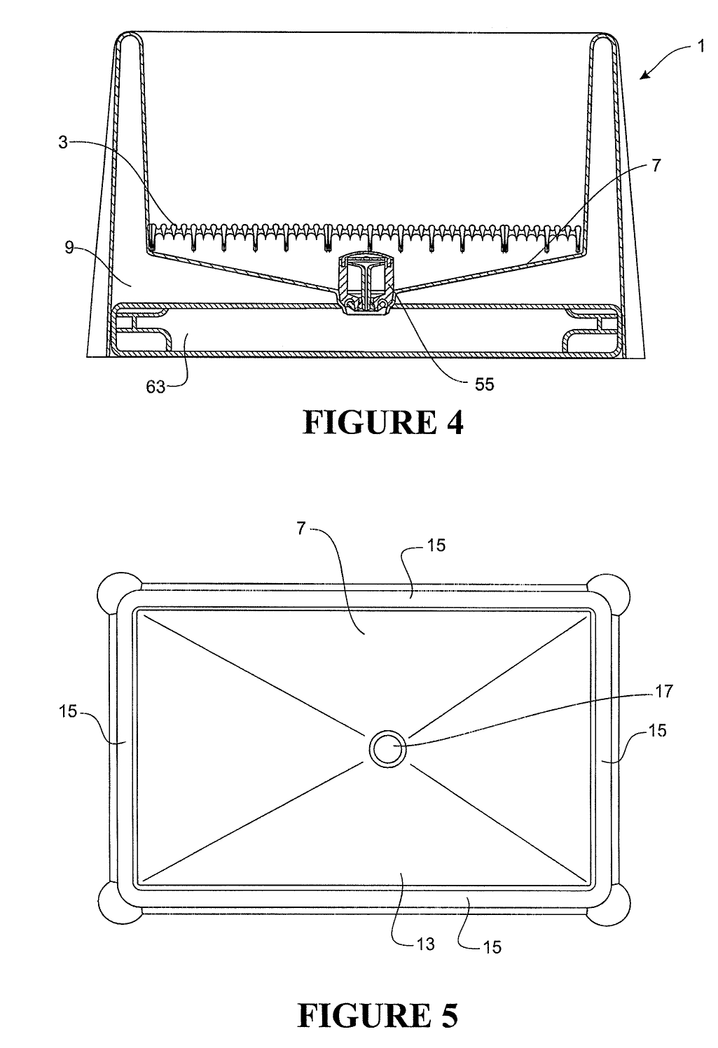

Referring to FIGS. 1 to 4, there is shown a first preferred toileting device indicated generally by reference numeral 1. The toilet device has a textured surface 3, and a liquid collecting structure. The liquid collecting structure has an upper tray 7, and a lower tray 9 that houses and supports the upper tray and textured surface. The upper tray supports the textured surface 3 above a drain that includes a water trap, for example an s-type drain 55.

The upper tray 7, as shown in FIG. 5, has a rectangular base 13 with four side walls 15. The base of the upper tray is angled from both longitudinal sides to form a nadir 17 offset from the centre of the tray. The side walls support the textured surface above the drain 55. An aperture 19 is located at the nadir for receiving the s-type drain 55. The nadir guides liquid to the drain through to the lower tray where liquid waste 21 is collected. The upper tray may have grooves (not shown) to encourage liquid waste towards the nadir 17.

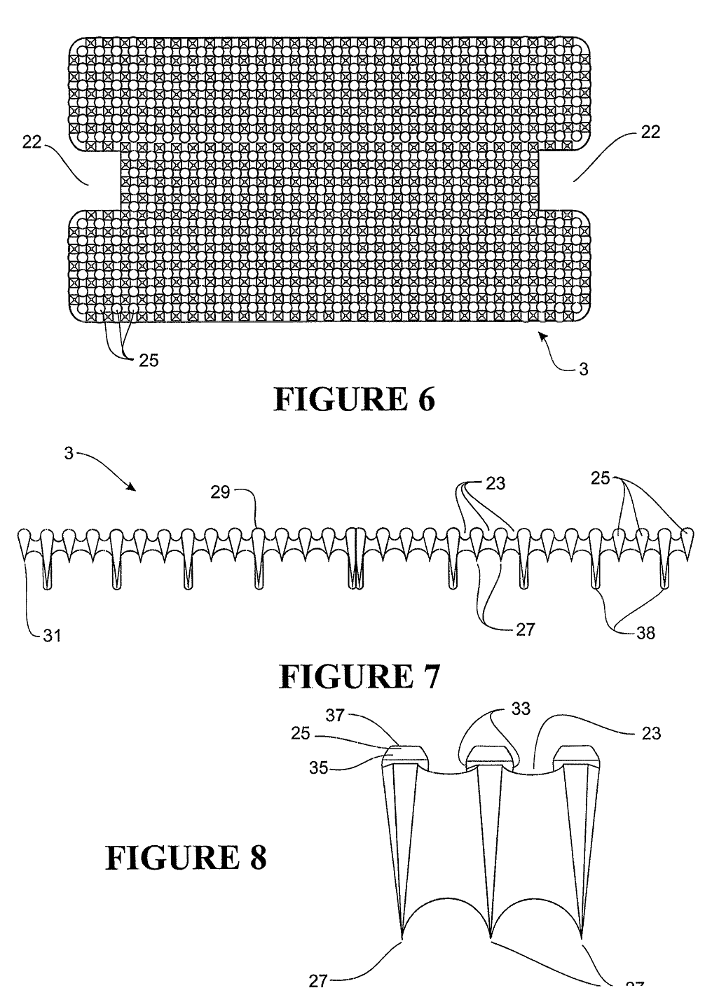

Referring to FIG. 6, the textured surface 3 is formed as a rectangular plate with rounded corners. At each end of the plate, open ended slots 22 are provided. These slots may be used as handles to remove and replace the textured surface on the upper tray as required. The textured surface is formed with a plurality of apertures 23 to allow the passage of liquid waste through to the upper tray. The apertures 23 are sized to substantially inhibit solid waste passing through to the upper tray, but allow passage of liquid waste.

The textured surface has a honeycomb structure formed from a plurality of projections or support lugs. The textured surface has a top surface 29, bottom surface 31, and apertures 23 extending from the top surface to the bottom surface.

The apertures 23 are evenly spaced along the length and width of the textured surface. Each aperture is square with tapered sides 33 from the top surface through to the lower surface. The sides of the neighbouring apertures form a point 27 on the lower surface of the textured surface. These points encourage any liquid waste to drip from the points down to the upper tray 7.

A cross section of the textured surface showing the tapered apertures, support lugs and points is shown in FIGS. 7 and 8.

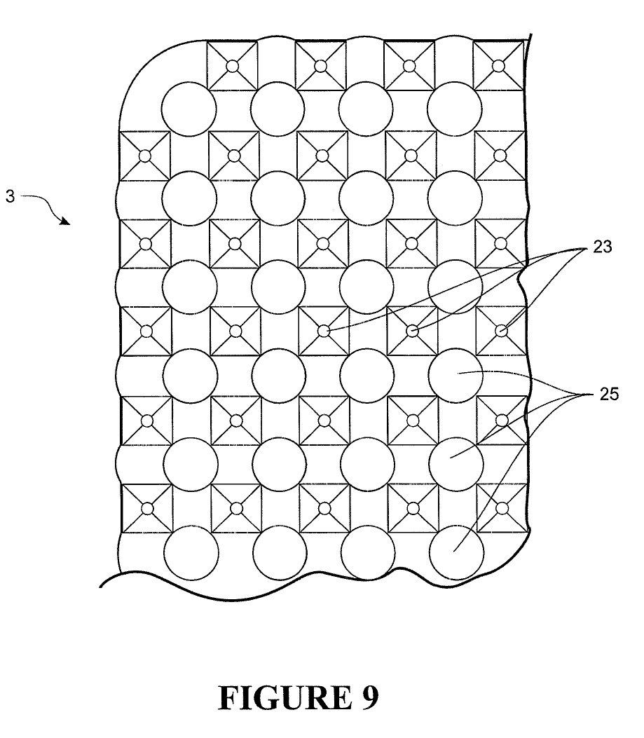

The textured surface 3 is formed from a plurality of projections or support lugs 25. FIG. 9 is a detail view of the top of the textured surface showing the support lugs. A support lug is located at the corner of each aperture 23. As shown in FIG. 8, each support lug has a substantially semi-spherical head 35. The head of each support lug is provided with a flat portion 37 at the top. The support lugs have a smooth surface without sharp points or edges. As shown in FIG. 7, a plurality of ribs 38 are provided on the bottom surface 31 of the textured surface to increase the strength of the textured surface.

The support lugs 25 provide areas for a domestic pet to stand that will keep their paws free from the waste collection area. The smoothness of the projections ensures that their paws are not hurt or damaged when in use. It will be appreciated that other shaped projections may be used, provided that the surface has no sharp points or edges.

Another function of the textured surface and the projections is to provide a surface to collect solid waste or other material and prevent any solid waste passing through to the trays. The solid waste is removed by the pet's owner and disposed.

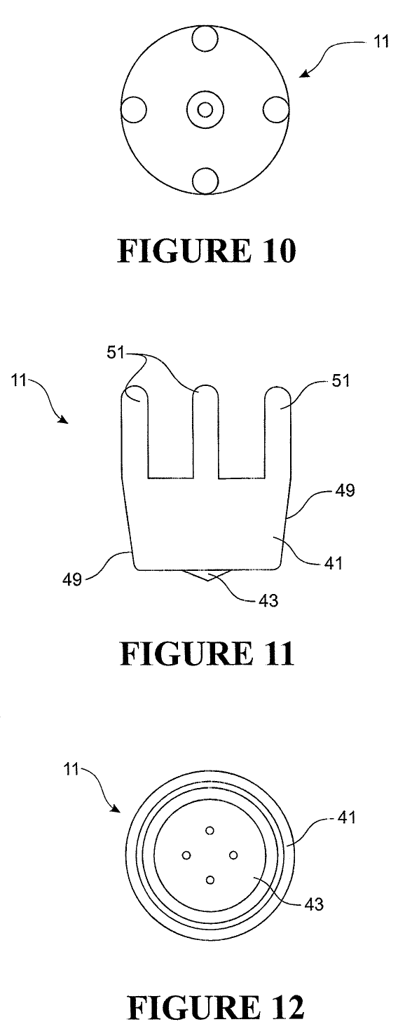

FIGS. 10 to 16 show a first embodiment of the s-type drain 11. The first embodiment of the s-type drain is formed as a two piece plug. The drain has an upper plug 41 that is received by the upper tray and a lower plug 43 that is received by the upper plug. FIG. 14 shows a detail view of the s-type drain installed in the upper tray.

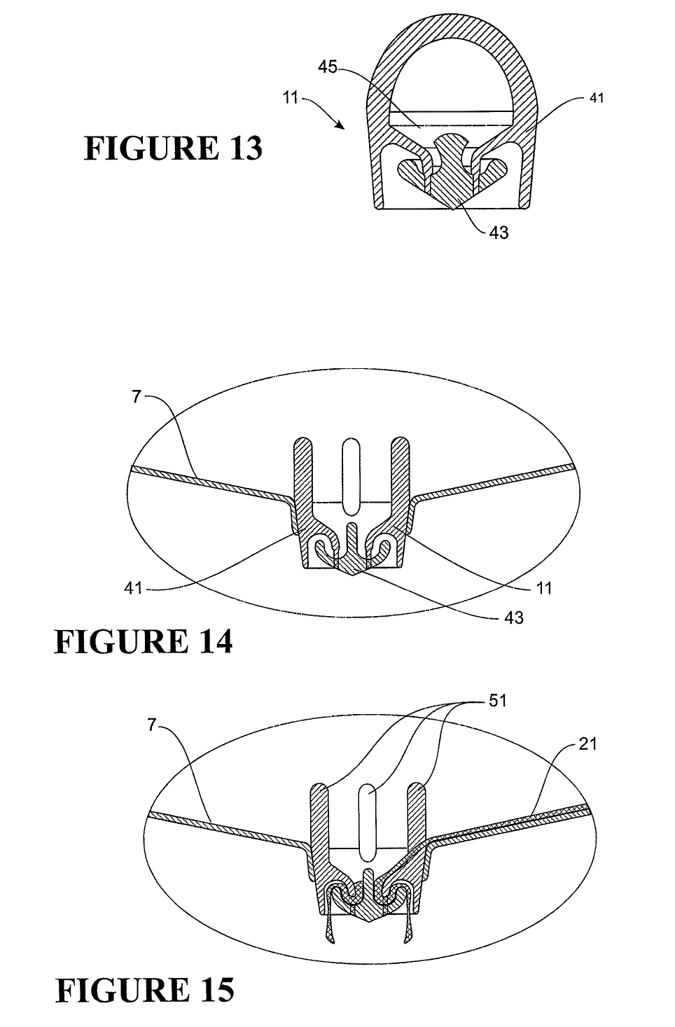

The interior of the upper plug is funnel shaped 45 and the lower plug has an annular groove 47. When assembled the funnel and annular groove form a drain passage in the shape of an “S” as shown in FIGS. 13 to 15. Any gas or odour is substantially inhibited from leaving the lower tray. This is because the gas is not able to pass over the rim into the groove and into the immediate environment. A vent may be provided to allow air to escape as the lower tray fills with liquid waste.

The upper plug of the first embodiment is circular when viewed from above. The upper plug has tapered sides 49 which are adapted to be received in the aperture formed in the upper tray. Four diametrically opposed removal lugs 51 are spaced around the perimeter of the plug.

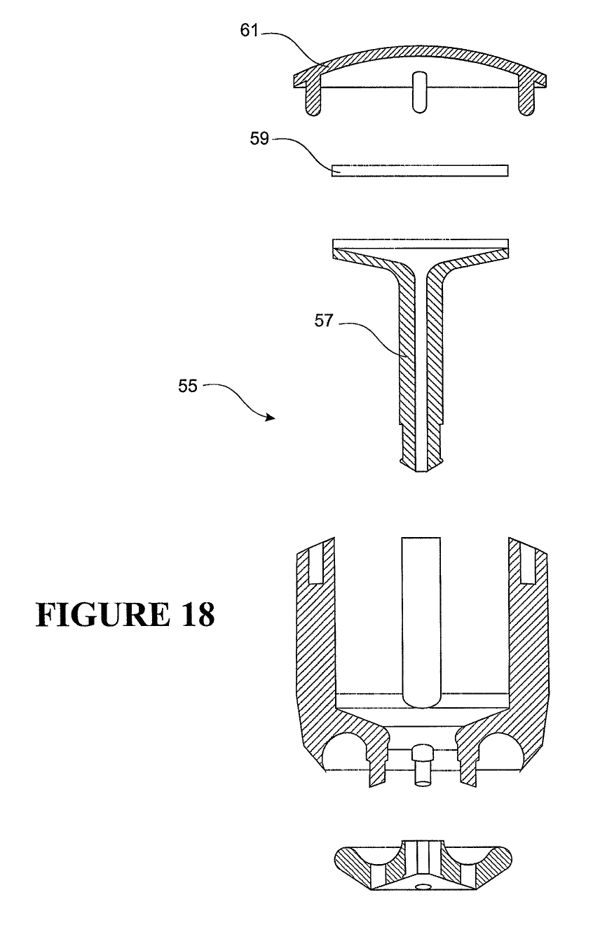

FIGS. 17 and 18 show a second embodiment of the s-type drain 55. The second embodiment is similar to the first embodiment, expect that it has a filter and an air vent or outlet 57. The air vent prevents gas or odour building up in the tray. The air vent is provided with a filter 59, such as a carbon filter, and a filter cap 61. The filter removes odour from the air as it passes from the vent into the immediate environment. Other conventional filter materials may be used.

The drain passage allows liquid waste to pass through the channel into the groove and flow over the rim, into the lower tray or an inner tray. FIG. 15 shows a detail view of the first embodiment of the s-type drain installed in the upper tray with liquid passing through the drain passage.

After use, a portion of liquid waste 21 remains in the groove of the drain. This remaining waste can be flushed through to the lower tray by pouring water through the textured surface into the toileting device. The water will flow through the drain and flush the remaining waste into the lower tray. Waste may also remain in other areas such as the textured surface or the upper tray. The cleaning action will flush any remaining waste through to the lower tray collection area.

In the preferred embodiment, the lower tray 9 has two catchment areas, for example two inner trays 63, 65. The drain will be positioned or configured so that any liquid waste 21 leaving the drain will flow into the first inner tray 63 and not the second inner tray 65. In the embodiment shown, the inner trays are placed side by side inside the lower tray. The drain 55 is positioned offset from the centre of the upper tray so that waste will flow into the first inner tray. When this first tray is filled, the upper tray 7 is lifted out, rotated 180° and placed back into the toileting device. In the new position, the drain 55 is located so that waste will flow into the second tray 65.

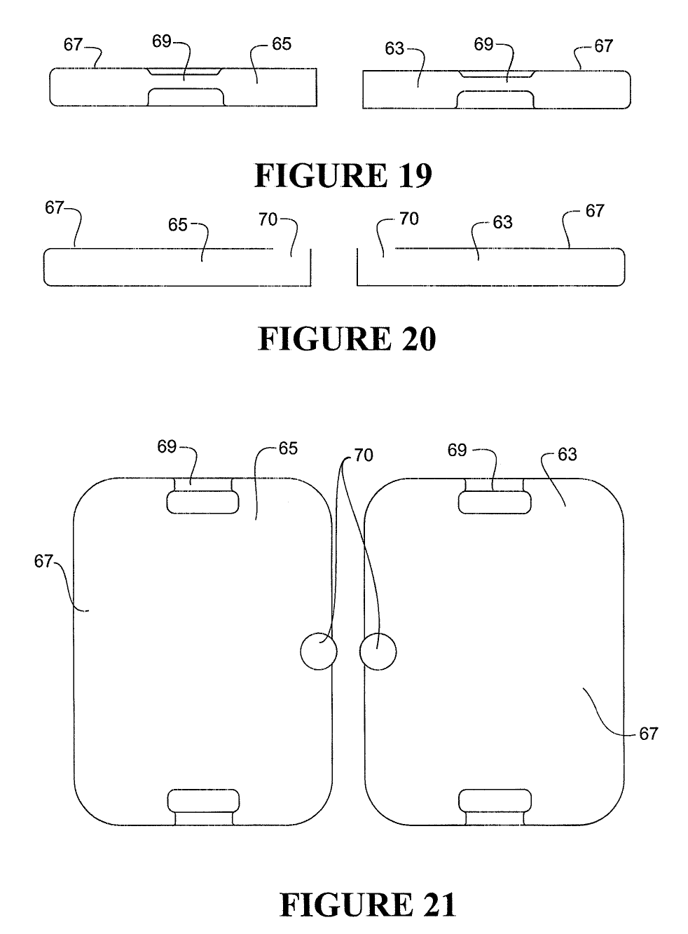

FIGS. 19-21 show the inner trays 63, 65. In the embodiment shown, the trays are blow moulded and have integral covers 67 to prevent liquid waste spilling during removal. The covers have apertures 70 that receive the lower portion of the drain. This ensures that liquid waste enters the trays directly and does not inadvertently spill or drip onto other areas. Alternatively, the drain may be connected to the trays by piping or be spaced above the aperture in the inner tray. Each inner tray is formed with handles 69 to assist in manual removal from the toileting device.

In an alternative embodiment, as the first tray fills up, it will periodically be removed and replaced by the second tray. Rather than rotating the upper tray, the second tray may slide along to replace the first tray. After the first tray has been emptied, it can be replaced into the toileting device into the original position of the second tray.

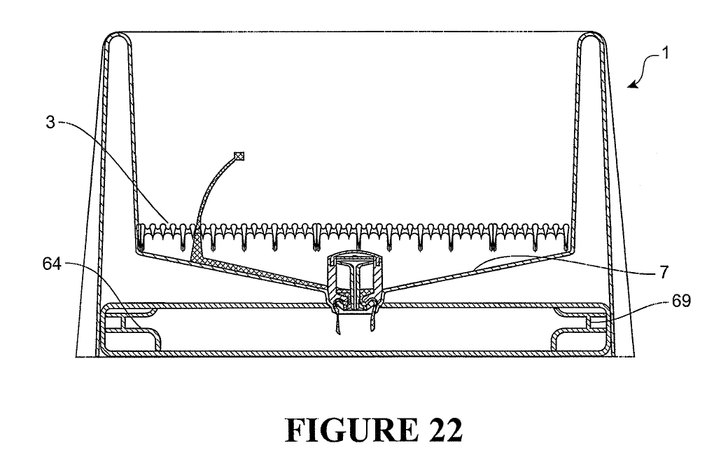

In another embodiment, there may be one inner tray 71 only. A cross section of a toileting device with one inner tray is shown in FIG. 22. In this embodiment, the inner tray is similar to the first and second trays described above, except for its dimension and location of the aperture 73 that receives the drain 55.

Alternatively, the lower tray may collect the liquid waste directly. The lower tray can be emptied via a drain or by removing the textured surface and upper tray. The lower tray can then be emptied or washed out as required.

Absorbent material may be placed on the textured surface. However, the amount of material required is less than that required for conventional toileting devices for domestic animals.

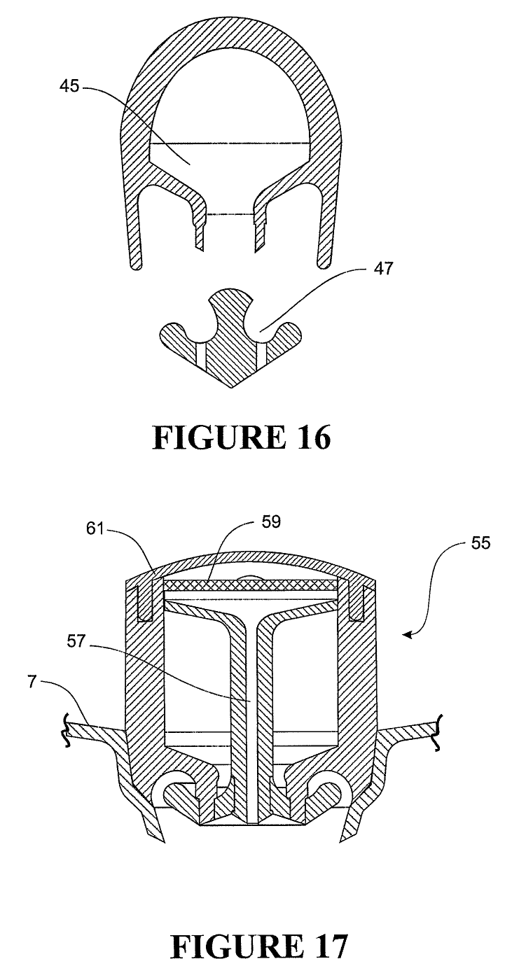

The upper tray, lower tray, air vent, textured surface and s-type drain are injection moulded plastic components. The inner trays are blow moulded components. The upper plug, lower plug and air vent are manufactured separately and connected together during assembly. FIG. 16 shows a cross section of the upper and lower plug before they are assembled together.

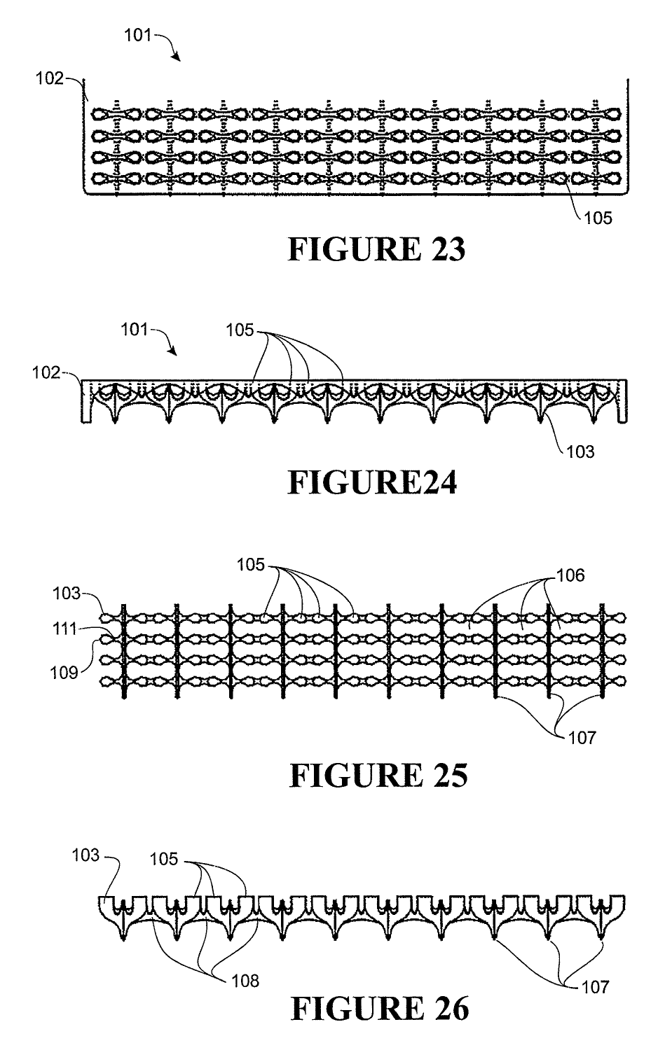

A second embodiment of the textured surface, indicated generally by reference numeral 101, is shown in FIGS. 23 to 30. The textured surface of this embodiment has a cover 102 and a draining surface 103.

Referring to FIG. 23, the draining surface 103 is formed as a generally rectangular plate. The draining surface has a honeycomb or grid structure formed from a plurality of projections 105 that are separated by a plurality of apertures 106. The projections are spaced evenly along its width and length in rows and columns. A number of elongate ribs 107 extend across the width of the drainage surface, connecting adjacent rows of projections. The projections are connected within the row by webs 108.

In plan view, each projection 105 has a teardrop shape with a wide, rounded end 109 and a narrower, pointed end 111. The orientation of the projections alternate along each row. The rounded end 109 of one projection faces the rounded end 109 of a projection on one side and the pointed end 111 faces the pointed end 111 of a projection on the other side.

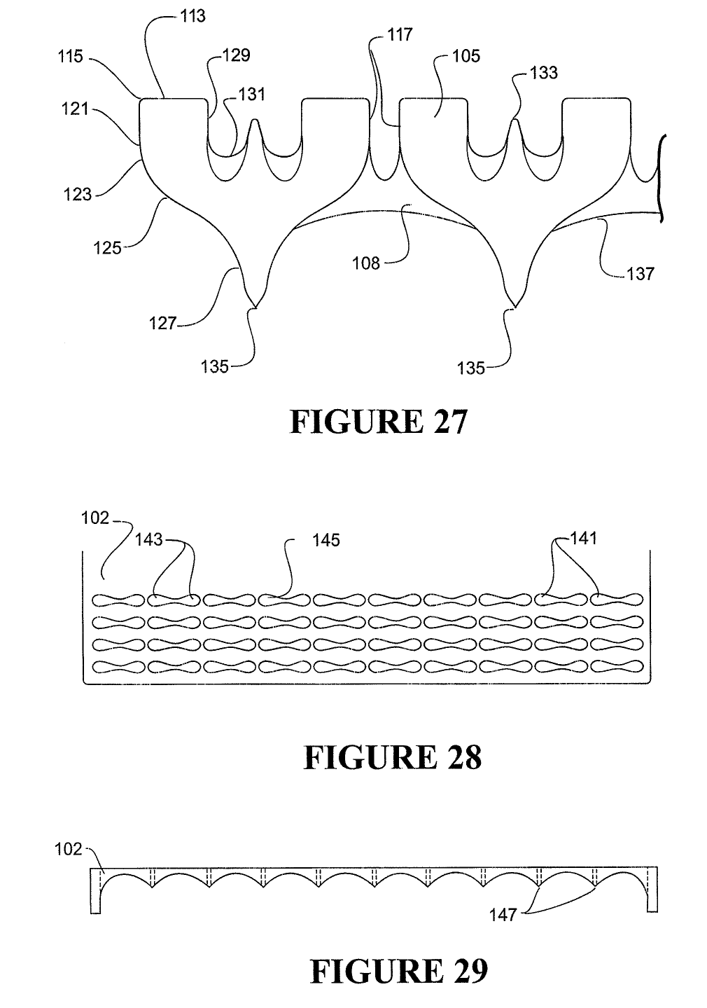

A cross section of the draining surface 103 showing the projections 105 and apertures 106 is shown in FIGS. 26 and 27. Each projection has a substantially flat or planar head 113. The projections have a smooth surface without sharp points or edges. In the preferred embodiment, the edges 115 have a radius of 0.5 mm. The radiused edges encourage liquid waste to travel from the flat surface of each projection and down the sides 117 of each projection.

When viewed from the front, the teardrop shape of each projection tapers towards a sharp edge 135 at the lower surface. The surface 121 of the projection corresponding to the wide, rounded end initially extends downwardly in a generally vertical direction 123 to a convex portion 125, then to a concave portion 127 that ends near the bottom edge of the rib. The edge of the projection corresponding to the pointed end extends downwardly in a generally vertical direction 129 then curves upwards 131 to join to the top edge of the rib 107.

In the embodiment shown, the ribs are positioned between the pointed ends 111 of the projections. Each rib 107 is radiused or curved at the top end 133 and the lower edge 135 is relatively sharp. The sharp edge encourages any liquid waste to drip downwards to the tray below. The height of the ribs 107 is below the height of the projections. The ribs connect adjacent rows and provide strength and rigidity to the structure.

Each projection is connected to the adjacent projections in the row by webs 108 extending between the projections. The webs have a concave upper surface and taper towards a sharp lower edge 137. The lower edge is curved to encourage any liquid to travel towards the sharp edge 135 of the ribs.

In this embodiment, the toileting device further includes a cover 102 positionable above the draining surface. The cover has a plurality of apertures 141 spaced in rows and columns corresponding to the spacing of the projections 105. The apertures 141 are sized to substantially inhibit solid waste passing through to the upper tray, but allow passage of liquid waste.

Each aperture is shaped generally as shown with two rounded ends 143 corresponding to the wide, rounded ends 109 of the projections 105. Between the ends, the aperture has a reduced width 145 corresponding to the pointed ends 111 of the projections. Liquid is drawn through the cover 102 and draining surface 103 via capillary action.

The cover has a plurality of downwardly projecting ribs 147 extending across its width. When assembled, the ribs engage between the rounded ends of the projections.

The cover 102 provides an area for a domestic pet to stand that will keep their paws free fiom the waste collection area. The smoothness of the cover ensures that their paws are not hurt or damaged when in use.

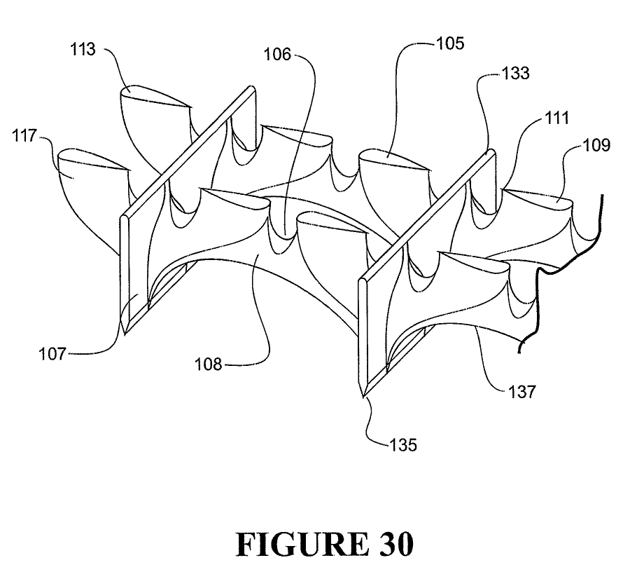

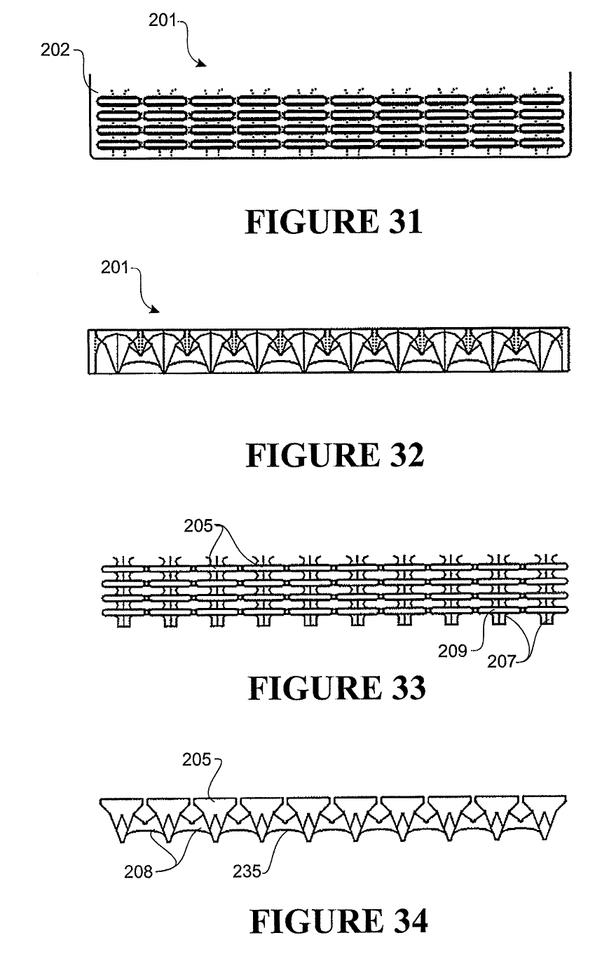

A third embodiment of the textured surface, indicated generally by reference numeral 201, is shown in FIGS. 30 to 36. This embodiment is similar to the second embodiment with a cover 202 and a draining surface 203. Unless described below, the features and operation should be considered to be the same as those described above.

The third preferred embodiment textured surface differs in that the projections 206 are generally rectangular with radiused or round ends.

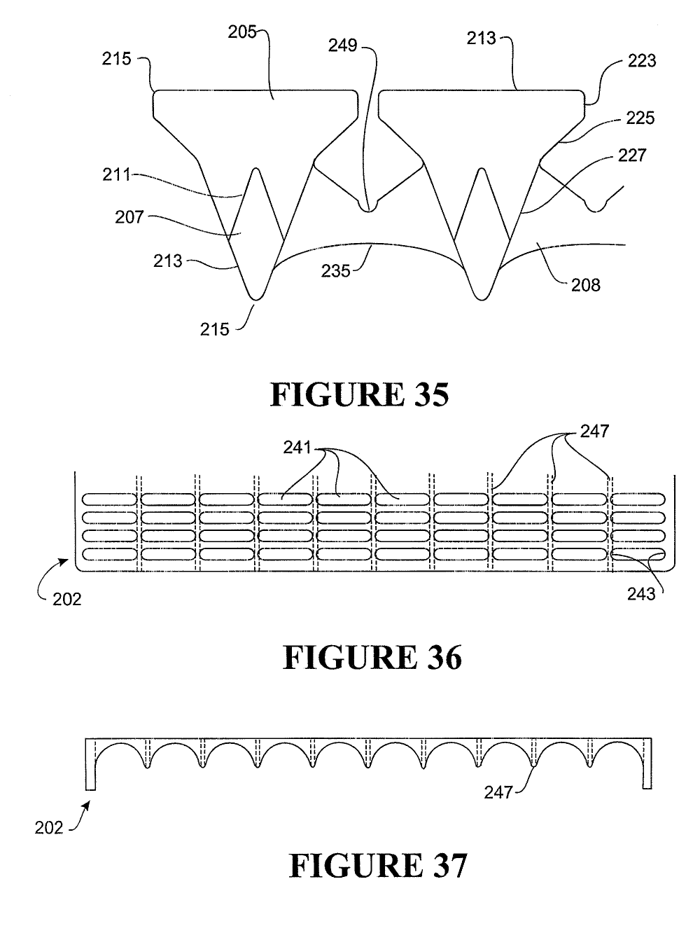

A cross section of the draining surface showing the projections and apertures is shown in FIGS. 34 and 35. Each projection has a substantially flat or planar head 213 with radiused edges 215. When viewed from the front, the sides 217 of the projections initially extend downwardly in a generally vertical direction 223, taper inward at an angle 225 relative to the vertical, and then taper at a lesser angle 227.

A number of elongate ribs 207 extend across the width of the drainage surface, connecting adjacent rows of projections. The ribs 207 extend from a central portion 209 of each projection to the adjacent row of projections. Each rib has a diamond-shaped cross section with inclined upper 211 and lower surfaces 213. The lower surfaces 211 meet at a edge 215, which encourage liquid to drip down towards the liquid collecting structure.

Each projection 205 is connected to the adjacent projections in the row by webs 208 extending between the projections. As for the second embodiment, the webs 208 taper towards a sharp lower edge 235. The lower edge of the web is curved to encourage any liquid to travel towards the sharp edge of the ribs. The upper surface of each web has two inclined faces that meet at a notch 249.

In this embodiment, the toileting device also includes a cover 202 positionable above the draining surface. The cover has a plurality of apertures 241 spaced in rows and columns corresponding to the spacing of the projections 205. The apertures are sized to substantially inhibit solid waste passing through to the upper tray, but allow passage of liquid waste. Each aperture is substantially rectangular with two rounded ends 243 corresponding to the shape of the projections. Liquid is drawn through the cover and draining surface via capillary action.

The cover has a plurality of downwardly projecting ribs 247 extending across its width. When assembled, the ribs engage in notches 249 of the webs.

Preferred embodiments of the invention have been described by way of example only and modifications may be made thereto without departing from the scope of the invention.

For example, the pattern of apertures in the textured surface may vary. Further, the shape of the apertures, projections, support lugs may vary, for example, they may have circular, oval, or hexangular shapes.

The preferred embodiment has been described with two inner trays. However, it will be appreciated that there may be more or less inner trays, for example, one or four. In these alternatives, the location of the nadir and drain and shape of the upper tray may be altered to accommodate the number of inner trays.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A toileting device for a domestic animal, comprising:
a textured surface having a plurality of apertures configured to allow the passage of liquid waste through the textured surface;
a liquid collecting structure positioned below the textured surface having a drain and a nadir for guiding the liquid waste to the drain.

2. A toileting device as claimed in claim 1, wherein the textured surface comprises a plurality of spaced apart projections.

3. A toileting device as claimed in claim 2, wherein the upper portion of the projections are generally smooth.

4. A toileting device as claimed in claim 2, wherein the upper edges of the projections are radiused or curved.

5. A toileting device as claimed in claim 2, wherein the lower portions of the projections have relatively sharp edges.

6. A toileting device as claimed in claim 2, further comprising elongate ribs connecting adjacent projections in one direction.

7. A toileting device as claimed in claim 5, further comprising webs extending between adjacent projections in another direction.

8. A toileting device as claimed in claim 2, wherein in plan view the projections are generally rectangular.

9. A toileting device as claimed in claim 2, wherein in plan view the projections are generally tear drop shaped.

10. A toileting device as claimed in claim 1, further comprising a cover with a plurality of apertures configured to allow the passage of liquid waste through the cover to the textured surface.

11. A toileting device as claimed in claim 1, wherein the liquid collecting structure comprises:
an upper tray; and
a lower tray separated from the upper tray by the drain.

12. A toileting device as claimed in claim 1, wherein the drain comprises a water trap.

13. A toileting device as claimed in claim 11, wherein the drain comprises:
an upper plug receivable by the upper tray, the upper plug having a substantially funnel shape, and a lower plug receivable by the upper plug, the lower plug having an annular groove,
the funnel and annular groove forming a drain passage when assembled.

14. A toileting device as claimed in claim 11, wherein the drain is positioned in a substantially central location of the upper tray.

15. A toileting device as claimed in claim 11, wherein the drain is positioned in a location offset from a central location of the upper tray.

16. A toileting device as claimed in claim 11, further comprising an air vent and an air filter.
